(19) United States
(12) Patent Application Publication
(10) Pub. No.: US 2026/0281349 A1
(43) Pub. Date: Sep. 17, 2026

(54) NON-SEPARABLE TRANSFORMS FOR LOW DELAY APPLICATIONS

(71) Applicant: InterDigital CE Patent Holdings, SAS, Paris (FR)

(72) Inventors: Karam Naser, Mouazé (FR); Fabrice Le Leannec, Betton (FR); Charles Bonnineau, Montreal (CA); Saurabh Puri, Saint-Lazare (CA)

(73) Assignee: InterDigital CE Patent Holdings, SAS, Paris (FR)

(21) Appl. No.: 19/469,321

(22) PCT Filed: Mar. 25, 2024
(86) PCT No.: PCT/EP2024/057956

§ 371 Date: Sep. 25, 2025

(30) Foreign Application Priority Data
Apr. 6, 2023 (EP) 23305508.6

(51) Int. Cl. H04N 19/12; H04N 19/159; H04N 19/172; H04N 19/174; H04N 19/176; H04N 19/30; H04N 19/60; H04N 19/70

(52) U.S. Cl. CPC H04N 19/12; H04N 19/159; H04N 19/172; H04N 19/174; H04N 19/176; H04N 19/30; H04N 19/60; H04N 19/70

(57) ABSTRACT

A method comprising: obtaining a current block of a picture; selecting a transform to be applied to the current block in a set of selectable transforms of a plurality of transforms comprising at least one non-separable transform, and, applying the selected transform to the current block; wherein a non-separable transform of the at least one non-separable transform is selectable for the current block based on a characteristic of a coding entity comprising the current block different from a sequence comprising the picture or a coding entity neighboring the current block.

### 1. CROSS REFERENCE TO RELATED APPLICATIONS

This application claims priority to European Application No. 23305508.6, filed Apr. 6, 2023, which is incorporated herein by reference in its entirety.

### 2. TECHNICAL FIELD

At least one of the present embodiments generally relates to a method and a device for improving non-separable transforms implementation in low delay video coding applications.

### 3. BACKGROUND

To achieve high compression efficiency, video coding schemes usually employ predictions and transforms to leverage spatial and temporal redundancies in a video content. During an encoding, pictures of the video content are divided into blocks of samples (i.e. Pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, a prediction residual sub-block or simply a residual sub-block, is transformed, quantized and entropy coded to generate an encoded video stream. To reconstruct the video, the compressed data is decoded by inverse processes corresponding to the transform, quantization and entropic coding.

One key aspect in video compression is the transform of the residual from the spatial domain to the frequency domain. Active research was conducted on this aspect, in particular for the definition and the implementation of the transform. For instance, recently, new transform tools such as LFNST (Low-Frequency non separable transforms) and NSPT (Non-SeParable Secondary Transform) were proposed to complement or replace a primary transform generally implemented in the form of a DCT.

It has been shown that LFNST and NSPT provide an interesting coding gain. However, this coding gain is obtained at a cost of an increase of the complexity which prevent the use of these transform tools for low delay video applications.

It is desirable to propose solutions allowing to overcome the above issues. In particular, it is desirable to propose solutions allowing using LFNST and NSPT in low delay video applications.

### 4. BRIEF SUMMARY

In a first aspect, one or more of the present embodiments provide a method comprising: obtaining a current block of a picture; selecting a transform to be applied to the current block in a set of selectable transforms of a plurality of transforms comprising at least one non-separable transform, and, applying the selected transform to the current block; wherein a non-separable transform of the at least one non-separable transform is selectable for the current block based on a characteristic of a coding entity comprising the current block different from a sequence comprising the picture or a coding entity neighboring the current block.

In a second aspect, one or more of the present embodiments provide a method comprising: obtaining a current block of a picture; determining an inverse transform to be applied to the current block in a set of selectable inverse transforms of a plurality of inverse transforms comprising at least one non-separable inverse transform, and, applying the determined inverse transform to the current block; wherein a non-separable inverse transform of the at least one non-separable inverse transform is selectable for the current block based on a characteristic of a coding entity comprising the current block different from a sequence comprising the picture or a coding entity neighboring the current block.

In an embodiment of the first or the second aspect, the coding entity is a slice comprising the current block and the characteristic is a slice type of the slice.

In an embodiment of the first or the second aspect, the coding entity is the picture comprising the current block and the characteristic is a value of a picture header level syntax element in a picture header of the picture comprising the current block.

In an embodiment of the first or the second aspect, the coding entity is a slice comprising the current block and the characteristic is a value of a slice header level syntax element in a slice header of the slice comprising the current block.

In an embodiment of the first or the second aspect, the coding entity is the picture comprising the current block and the characteristic is a picture parameter set level syntax element in picture parameter set to which refer the picture comprising the current block.

In an embodiment of the first or the second aspect, the coding entity is at least one block in a causal neighborhood of the current block and the characteristic is a characteristic of the at least one block in the causal neighborhood of the current block.

In an embodiment of the first or the second aspect, the coding entity is a slice comprising the current block and the characteristic is a temporal depth of the slice comprising the current block.

In a third aspect, one or more of the present embodiments provide a device comprising electronic circuitry configured for: obtaining a current block of a picture; selecting a transform to be applied to the current block in a set of selectable transforms of a plurality of transforms comprising at least one non-separable transform, and, applying the selected transform to the current block; wherein a non-separable transform of the at least one non-separable transform is selectable for the current block based on a characteristic of a coding entity comprising the current block different from a sequence comprising the picture or a coding entity neighboring the current block.

In a fourth aspect, one or more of the present embodiments provide a device comprising electronic circuitry configured for: obtaining a current block of a picture; determining an inverse transform to be applied to the current block in a set of selectable inverse transforms of a plurality of inverse transforms comprising at least one non-separable inverse transform, and, applying the determined inverse transform to the current block; wherein a non-separable inverse transform of the at least one non-separable inverse transform is selectable for the current block based on a characteristic of a coding entity comprising the current block different from a sequence comprising the picture or a coding entity neighboring the current block.

In an embodiment of the third or the fourth aspect the coding entity is a slice comprising the current block and the characteristic is a slice type of the slice.

In an embodiment of the third or the fourth aspect the coding entity is the picture comprising the current block and the characteristic is a value of a picture header level syntax element in a picture header of the picture comprising the current block.

In an embodiment of the third or the fourth aspect the coding entity is a slice comprising the current block and the characteristic is a value of a slice header level syntax element in a slice header of the slice comprising the current block.

In an embodiment of the third or the fourth aspect the coding entity is the picture comprising the current block and the characteristic is a picture parameter set level syntax element in picture parameter set to which refer the picture comprising the current block.

In an embodiment of the third or the fourth aspect the coding entity is at least one block in a causal neighborhood of the current block and the characteristic is a characteristic of the at least one block in the causal neighborhood of the current block.

In an embodiment of the third or the fourth aspect the coding entity is a slice comprising the current block and the characteristic is a temporal depth of the slice comprising the current block.

In a fifth aspect, one or more of the present embodiments provide a computer program comprising program code instructions for implementing the method according to the first or the second aspect.

In a sixth aspect, one or more of the present embodiments provide a Non-transitory information storage medium storing program code instructions for implementing the method according to the first or the second aspect.

### 5. BRIEF SUMMARY OF THE DRAWINGS

FIG. 1 illustrates schematically an example of context in which embodiments are implemented;

FIG. 2 illustrates schematically an example of partitioning undergone by a picture of pixels of an original video;

FIG. 3 depicts schematically a method for encoding video data;

FIG. 4 depicts schematically a method for decoding video data;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6 represents schematically an example of embodiment allowing reducing a complexity of LFNST and NSPT in an encoding module;

FIG. 7 represents schematically an example of embodiment allowing reducing a complexity of LFNST and NSPT in a decoding module; and,

FIG. 8 illustrates an example of Group Of Picture (GoP) structure employed in low delay coding configurations.

### 6. DETAILED DESCRIPTION

The following examples of embodiments are described in the context of a video format similar to VVC (ISO/IEC 23090-3-MPEG-I: Versatile Video Coding (VVC)/ITU-T H.266). However, these embodiments are not limited to the video coding/decoding method corresponding to VVC. These embodiments are in particular adapted to various video formats comprising for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), AV1, AV2 and VP9.

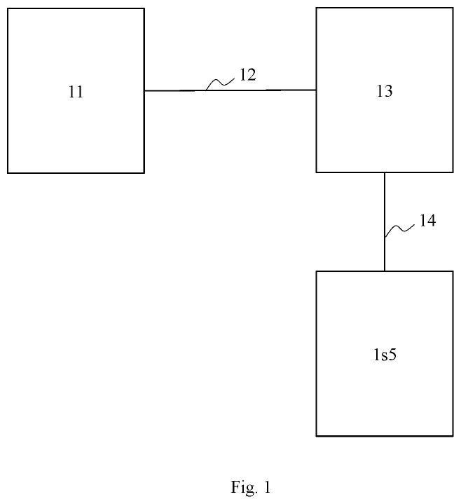

FIG. 1 describes an example of a context in which following embodiments can be implemented.

In FIG. 1, a system 11, that could be a camera, a storage device, a computer, a server or any device capable of delivering a video stream, transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display 15 are comprised in a TV, a computer, a tablet, a smartphone, a head-mounted display, etc.

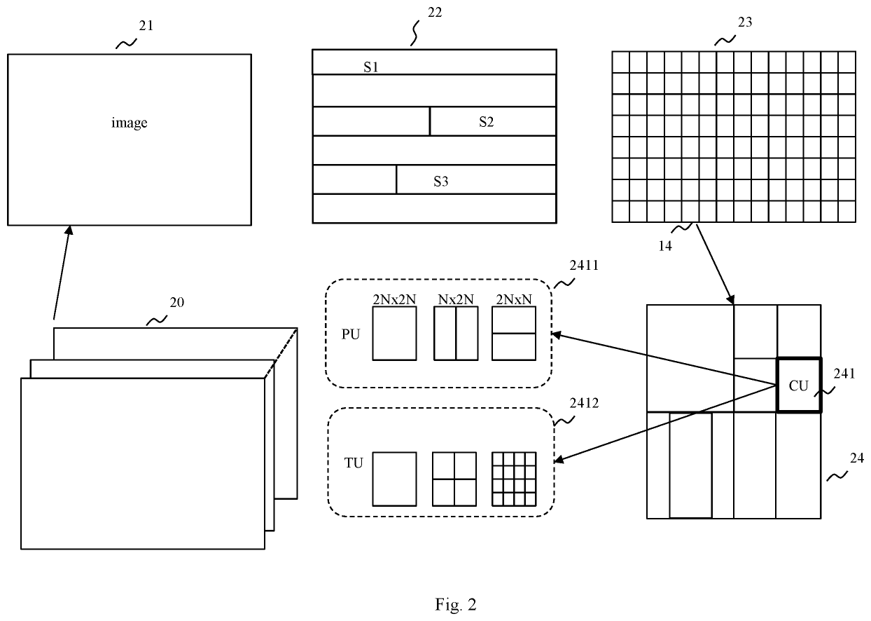

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTU covering a rectangular region of a picture. In some cases, a tile could be divided into one or more bricks, each of which consisting of at least one row of CTU within the tile. Above the concept of tiles and bricks, another encoding entity, called slice, exists, that can contain at least one tile of a picture or at least one brick of a tile.

In the example in FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CU (i.e. child nodes). Each CU becomes a leaf of the hierarchical tree if it is not further partitioned in smaller CU or becomes a parent node of smaller CU (i.e. child nodes) if it is further partitioned.

In the example of FIG. 2, the CTU 24 is first partitioned in “4” square CU using a quadtree type partitioning. The upper left CU is a leaf of the hierarchical tree since it is not further partitioned, i.e. it is not a parent node of any other CU. The upper right CU is further partitioned in “4” smaller square CU using again a quadtree type partitioning. The bottom right CU is vertically partitioned in “2” rectangular CU using a binary tree type partitioning. The bottom left CU is vertically partitioned in “3” rectangular CU using a ternary tree type partitioning.

During the coding of a picture, the partitioning is adaptive, each CTU being partitioned so as to optimize a compression efficiency of the CTU criterion.

In HEVC appeared the concept of prediction unit (PU) and transform unit (TU). Indeed, in HEVC, the coding entity that is used for prediction (i.e. a PU) and transform (i.e. a TU) can be a subdivision of a CU. For example, as represented in FIG. 1, a CU of size 2N×2N, can be divided in PU 2411 of size N×2N or of size 2N×N. In addition, said CU can be divided in “4” TU 2412 of size N× N or in “16” TU of size (N/2)×(N/2).

One can note that in VVC, except in some particular cases, frontiers of the TU and PU are aligned on the frontiers of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

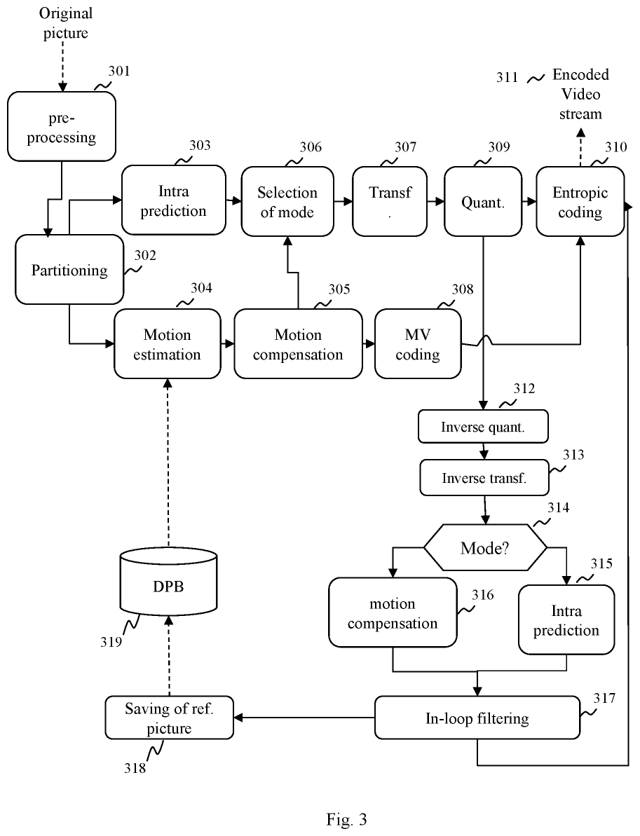

FIG. 3 depicts schematically a method for encoding a video stream executed by an encoding module. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc. For each block, the encoding module determines a coding mode between an intra prediction and an inter prediction.

The intra prediction consists of predicting, in accordance with an intra prediction method, during a step 303, the pixels of a current block from a prediction block derived from pixels of reconstructed blocks situated in a causal vicinity of the current block to be coded. The result of the intra prediction is a prediction mode indicating which pixels of the blocks in the vicinity to use, and a residual block resulting from a calculation of a difference between the current block and the prediction block.

The inter prediction consists of predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. In some implementations, a plurality of type of transforms can be applied to a transformed residual block. Indeed, in addition to DCT-II, a Multiple Transform Selection (MTS) scheme is used for both inter and intra predicted blocks. It uses multiple selected transforms from the DCT-VIII/DST-VII.

Another scheme related to the transform called Low-frequency non-separable transform (LFNST) has been proposed. LFNST is applied between a forward primary transform (i.e. the usual transform of step 307) and a quantization (corresponding to a step 309). LFNST is applied only to blocks for which an INTRA prediction had been selected.

LFNST defined a plurality of LFNST sets. Each set comprises a plurality of transform kernels. For instance, in recent versions of LFNST, 35 LFNST sets are defined, each comprising 3 transform kernels.

Each LFNST kernel has a given dimension. For instance, recent versions of LFNST defines 3 kernels with the following dimension:
LFNST4: 16×16
LFNST8: 32×64
LFNST16: 32×96

In LFNST, each LFNST set is associated to a range of INTRA mode. For instance, the DC and planar mode are associated to one LFNST set.

Once a LFNST set had been identified for an INTRA predicted block based on the INTRA mode of the block, the encoding module has “4” possible options for the block:
1. No LFNST;
2. LFNST with the first transform kernel of the identified LFNST set;
3. LFNST with the second transform kernel of the identified LFNST set;
4. LFNST with the third transform kernel of the identified LFNST set.

The determination of the best option for the block is based on a rate distortion optimisation. The complexity of LFNST comes essentially from this rate distortion optimisation. This complexity prevents the use of LFNST in many cases.

Recently, it had been proposed to replace the two stages transform, i.e., the primary transform (for instance a DCT-II) and the secondary transform (LFNST) by a single separable transform called NSPT (Non-SeParable Secondary Transform). NSPT defines a plurality of NSPT sets each comprising a plurality of transform kernels. For instance, in an implementation, NSPT defines “35” NSPT sets each comprising “3” transform kernels. As in LFNST, each transform kernel has a given dimension. The determination of a NSPT set for a block us based on the size of the block. Once the NSPT set is determined, the encoding module has “4” possible options for the block:
1. No NSPT;
2. NSPT with the first transform kernel of the identified NSPT set;
3. NSPT with the second transform kernel of the identified NSPT set;
4. NSPT with the third transform kernel of the identified NSPT set.

The determination of the best option for the block is based on a rate distortion optimisation. Again, the complexity of NSPT comes essentially from this rate distortion optimisation. This complexity prevents the use of NSPT in many cases.

The transformed block is then quantized during a step 309.

Note that the encoding module can skip the transform and apply quantization directly to the non-transformed residual signal. When the current block is coded according to an intra prediction mode, an intra prediction mode and the transformed and quantized residual block are encoded by an entropic encoder during a step 310. When the current block is encoded according to an inter prediction, when appropriate, a motion vector of the block is predicted from a prediction vector selected from a set of motion vectors corresponding to reconstructed blocks situated in the vicinity of the block to be coded. The motion information is next encoded by the entropic encoder during step 310 in the form of a motion residual and an index for identifying the prediction vector. The transformed and quantized residual block is encoded by the entropic encoder during step 310.

Note that the encoding module can bypass both transform and quantization, i.e., the entropic encoding is applied on the residual without the application of the transform or quantization processes. The result of the entropic encoding is inserted in an encoded video stream 311.

Metadata such as SEI (supplemental enhancement information) messages can be attached to the encoded video stream 311. A SEI message as defined for example in standards such as AVC, HEVC or VVC is a data container associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the prediction block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the prediction direction corresponding to the current block is used for reconstructing the prediction block of the current block. The prediction block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

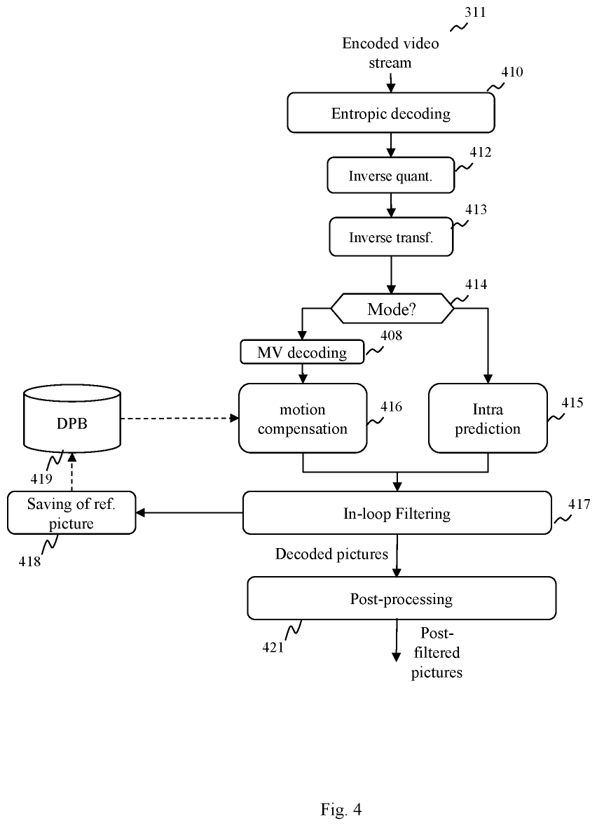

FIG. 4 depicts schematically a method for decoding the encoded video stream 311 encoded according to method described in relation to FIG. 3 executed by a decoding module. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block.

If the block has been encoded according to an inter prediction mode, the entropic decoding allows to obtain, when appropriate, a prediction vector index, a motion residual and a residual block. During a step 408, a motion vector is reconstructed for the current block using the prediction vector index and the motion residual.

If the block has been encoded according to an intra prediction mode, entropic decoding allows to obtain the intra prediction mode and a residual block. Steps 412, 413, 414, 415, 416 and 417 implemented by the decoding module are in all respects identical respectively to steps 412, 413, 414, 415, 416 and 417 implemented by the encoding module. If LFNST was applied on the current block on the encoder side, an inverse LFNST transform is applied between the inverse-quantization and an inverse primary transform (between steps 412 and 413). Similarly, if NSPT was applied on the current block on the encoder side, an inverse NSPT transform replaces the primary and secondary transforms (for instance inverse DCT-II and inverse LFNST) in step 413.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given image. The decoded picture can also be outputted by the decoding module for instance to be displayed.

The post-processing step 421 can comprise an inverse color transform (e.g. conversion from YCbCr 4:2:0 to RGB 4:4:4), an inverse mapping performing the inverse of the remapping process performed in the pre-processing of step 301 and a post-filtering for improving the reconstructed pictures based for example on filter parameters provided in a SEI message.

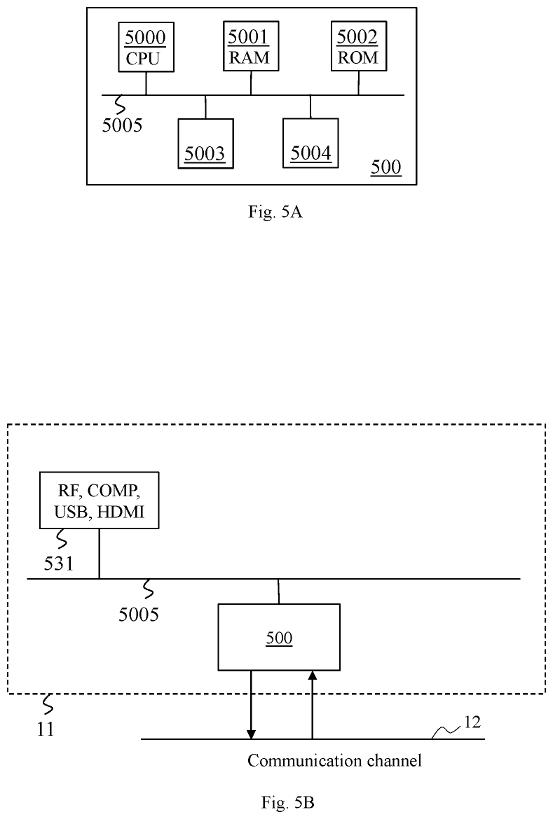

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this apparatus is in charge of encoding the video stream. The decoding module is for example comprised in the system 13. The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or equipment. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

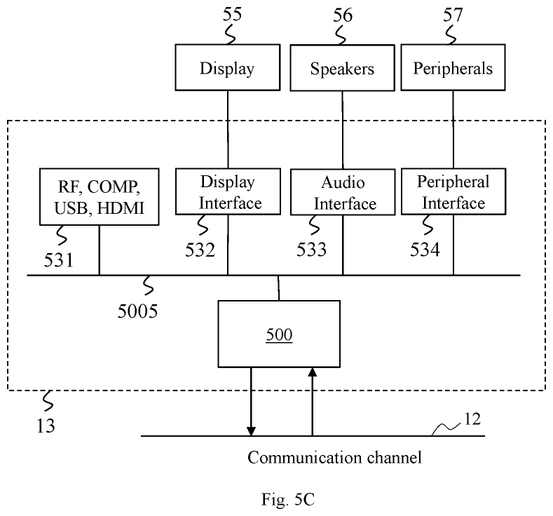

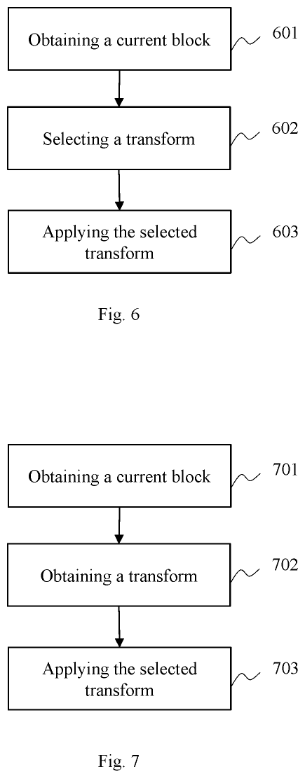

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4, an encoding method described in relation to FIG. 3, and methods described in relation to FIG. 6 or 7, these methods comprising various aspects and embodiments described below in this document.

All or some of the algorithms and steps of the methods of FIGS. 3, 4, 6 and 7 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted to implement at least partially the methods of FIGS. 3, 4, 6 and 7.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5D, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 55, speakers 56, and other peripheral devices 57. The display system 55 of various embodiments includes one or more of, for example, a touchscreen display, an organic light-emitting diode (OLED) display, a curved display, and/or a foldable display. The display 55 can be for a television, a tablet, a laptop, a cell phone (mobile phone), a head mounted display or other devices. The display system 55 can also be integrated with other components (for example, as in a smart phone), or separate (for example, an external monitor for a laptop). The other peripheral devices 57 include, in various examples of embodiments, one or more of a stand-alone digital video disc (or digital versatile disc) (DVR, for both terms), a disk player, a stereo system, and/or a lighting system. Various embodiments use one or more peripheral devices 57 that provide a function based on the output of the system 13. For example, a disk player performs the function of playing an output of the system 13.

In various embodiments, control signals are communicated between the system 13 and the display system 55, speakers 56, or other peripheral devices 57 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel corresponding to the communication channel 54 in FIG. 5A via the communication interface 5004. The display system 55 and speakers 56 can be integrated in a single unit with the other components of system 13 in an electronic device such as, for example, a television. In various embodiments, the display interface 532 includes a display driver, such as, for example, a timing controller (T Con) chip.

The display system 55 and speaker 56 can alternatively be separate from one or more of the other components. In various embodiments in which the display system 55 and speakers 56 are external components, the output signal can be provided via dedicated output connections, including, for example, HDMI ports, USB ports, or COMP outputs.

FIG. 5B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5D.

Various elements of system 11 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 11, the processing module 500 is interconnected to other elements of said system 11 by the bus 5005.

The communication interface 5004 of the processing module 500 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 11 or comprised in the system 11. In that case, the processing module take in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for decoding the last significant coefficient of a block from an encoded video stream.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for signaling a last significant coefficient of a block in an encoded video stream.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the encoded video stream and SEI messages of a described embodiment. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

In the following, various embodiments propose to reduce the complexity of LFNST and NSPT.

FIG. 6 represents schematically an example of embodiment allowing reducing a complexity of LFNST and NSPT in an encoding module.

The process of FIG. 6 is for example executed by the processing module 500 of the system 11. The process of FIG. 6 is for example executed before the step of transforming 307.

In a step 601, the processing module 500 obtains a current block to transform. The block is for instance a residual block resulting from an intra prediction.

In a step 602, the processing module 500 selects a transform to be applied to the current block in a set of selectable transforms of plurality of transforms comprising at least one non-separable transform, i.e., comprising LFNST and/or NSPT. For instance, the plurality of transforms comprises a DCT-II, a DCT-VIII, a DST-VII and LFNST and/or NSPT. In an embodiment, each selectable transform in the plurality is successively tested in a rate distortion optimization to determine the best transform for the current block.

FIG. 7 represents schematically an example of embodiment allowing reducing a complexity of LFNST and NSPT in a decoding module.

The process of FIG. 7 is for example executed by the processing module 500 of the system 13. The process of FIG. 7 is for example executed before the step of inverse transform 413.

In a step 701, the processing module 500 obtains a current block to inverse transform. The current block is for example an inverse quantized transformed residual.

In a step 702, the processing module 500 determines the inverse transform to be applied to the current block in a set of selectable inverse transforms of a plurality of inverse transforms comprising at least one non-separable inverse transform, i.e., comprising an inverse LFNST and/or an inverse NSPT. For instance the plurality of inverse transforms comprises an inverse DCT-II, an inverse DCT-VIII, an inverse DST-VII and an inverse LFNST and/or an inverse NSPT.

In a step 703, the processing module applies the determined inverse transform to the current block.

In a first embodiment, the non-separable transforms are selectable for the current block based on a slice type of a slice comprising the current block.

Since LFNST and NSPT is applied to residual blocks resulting from an intra prediction, LFNST and NSPT are particularly adapted to I-slices (An I-slice is a slice wherein all blocks are encoded in intra). However, for non-I slices, it is less efficient to use LFNST/NSPT.

In a first variant of the first embodiment, LFNST and NSPT are selectable only for blocks comprised in I-slices. In that case, LFNST and NSPT is deactivated for non-I-slices.

In a second variant of the first embodiment, LFNST and NSPT are selectable only for blocks comprised in I-slices and P-slices (P-slice is a slice wherein blocks are encoded either in intra or inter mono-directional mode). In that case, LFNST and NSPT is deactivated for B-slices (slices in which bi-prediction is allowed).

In a third variant, a high-level syntax element is signaled, for instance in a sequence parameter set (SPS), to indicate that LFNST or NSPT is deactivated for non-I slices (respectively for B-slices).

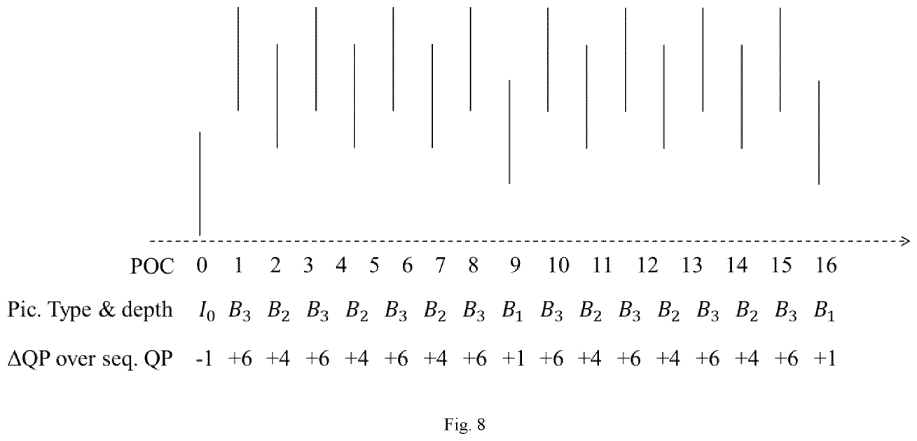

FIG. 8 illustrates an example of Group Of Picture (GoP) structure employed in low delay coding configurations. In this example, successive pictures are being assigned a quantization parameter (QP) which varies from picture to picture, making a rate allocation among different pictures of the GoP highly unequal.

More precisely, the QP of a picture is set according to a virtual hierarchical arrangement between pictures. This virtual hierarchy assigns a temporal depth value to each picture, and the QP assigned to a given picture depends on the picture's temporal depth value. For instance, on FIG. 8, picture type B₃ designates a B-picture with temporal depth value equal to “3” and picture type B₂ designates a B-picture with temporal depth value equal to “2”. FIG. 8 also shows the QP assigned to each picture temporal depth, relative to a sequence-level QP parameter.

Note the temporal depth value is not signaled in the video data but is only used at encoder side to organize the GOP structure.

In a second embodiment, the use of a non-separable transform (LFNST or NSPT) is activated/deactivated at picture level, through a LFNST/NSPT flag overriding mechanism. This overriding mechanism comprises a signaling of a flag in the picture header indicating if a LFNST/NSPT usage flag signaled at the SPS level is overridden for a current picture concerned by the picture header or not. If overridden, a LFNST/NSPT usage flag is signaled in the picture header, to indicate if LFNST/NSPT is used in the current picture or not.

In a variant of the second embodiment, if it is signaled at the picture level that the SPS-level LFNST/NSPT flag is overridden, the value of the picture header level LFNST/NSPT usage flag is not signaled but inferred at the inverse of the value of the SPS-level LFNST/NSPT usage flag.

In a variant of the second embodiment, no picture header level LFNST/NSPT overriding flag is signaled in the picture header, but a LFNST/NSPT usage flag is systematically coded in the picture header.

In a variant of the second embodiment, the use of a non-separable transform (LFNST or NSPT) and MTS is activated/deactivated at picture level, through a LFNST/NSPT and MTS flag overriding mechanism. This overriding mechanism comprises a signaling of a flag in the picture header indicating if a LFNST/NSPT and MTS usage flag signaled at the SPS level is overridden for a current picture concerned by the picture header or not. If overridden, a LFNST/NSPT usage flag is signaled in the picture header, to indicate if LFNST/NSPT is used in the current picture or not. If overridden, explicit MTS and LFNST/NSPT usage flags are signaled in the slice header.

In a variant of the second embodiment, the overriding mechanism (for LFNST/NSPT or for LFNST/NSPT and MTS) happen at a slice header level. A slice header level flag indicates if SPS level LFNST/NSPT usage flags (or SPS level LFNST/NSPT and MTS usage flags) are overridden in a given slice. If overridden, explicit MTS and LFNST/NSPT usage flags are signaled in the picture header.

In a variant of the second embodiment, the overriding mechanism (for LFNST/NSPT or for LFNST/NSPT and MTS) happen at a picture parameter set (PPS) level. A PPS level flag indicates if SPS level LFNST/NSPT usage flags (or SPS level LFNST/NSPT and MTS usage flags) are overridden in a picture referring to this PPS. If overridden, explicit MTS and LFNST/NSPT usage flags are signaled in the PPS.

As can be seen, in the second embodiment, the non-separable transforms (LFNST and NSPT) are selectable in the plurality of transforms in steps 602 and 702 if:
a value of a picture header level syntax element in picture header of a picture comprising the current block, or,
a value of a slice header level syntax element in a slice header of a slice comprising the current block,
a value of a PPS level syntax element in a PPS to which refer the picture comprising the current block,
indicates that LFNST and/or NSPT is allowed for the current block.

In non-I slices, LFNST/NSPT can be limited to certain blocs depending on the characteristics of blocks in a causal neighborhood of the current block.

In a third embodiment, the non-separable transforms (LFNST and NSPT) are selectable in the plurality of transforms in steps 602 and 702 based on a characteristic of at least one block in a causal neighborhood of the current block.

For example, in the third embodiment, LFNST and NSPT are selectable for a current block if most of the block in a causal neighborhood of the current block are coded in intra, thus limiting the LFNST/NSTP usage to small proportion of blocks where intra is used excessively. For example, LFNST and NSPT are selectable for a current block if more than the half of the block in a causal neighborhood of the current block are coded in intra.

In another example, LFNST and NSPT is selectable for a current block if most of the blocks in a causal neighborhood of the current block are coded in inter, thus limiting LFNST/NSPT usage where the current block is difficult to encode and LFNST is expected to provide significant coding gain.

In a variant of the third embodiment, a high-level syntax (for instance in SPS) element indicates that LFNST/NSPT usage is based on a characteristic of at least one block in a causal neighborhood of the current block.

In the first, second and third embodiment, the complexity related to LFNST and NSPT is limited by controlling on which block LFNST and NSPT can be applied.

In a fourth embodiment, the complexity of LFNST and NSPT is reduced in the encoding module by reducing the number of possible choices during the rate distortion optimization. This can be achieved by reducing the number of LFNST/NSPT kernels considered (i.e. selectable) for a current block during the rate distortion optimization. When the number of kernels is reduced, the corresponding signaling is modified.

TABLE TAB1

| | LFNST/NSPT | | |
|---|---|---|---|
| | kernel index | First bit | Second bit |
| Default case | 0 | 0 | 0 |
| | 1 | 0 | 1 |
| | 2 | 1 | 0 |
| | 3 | 1 | 1 |
| 1 kernel allowed | 0 | 0 | — |
| | 1 | 1 | — |
| 2 kernels allowed | 0 | 0 | — |
| | 1 | 1 | 0 |
| | 2 | 1 | 1 |

Table TAB1 illustrates an a binarization of the index of the LFNST/NSPT transform of a LFNST/NSPT set. In this table, LFNST/NSPT index=0 indicates no use of LFNST/NSPT. LFNST/NSPT index=1 indicates a use of the first LFNST/NSPT kernel. LFNST/NSPT index=2 indicates a use of the second LFNST/NSPT kernel. LFNST/NSPT index=3 indicates a use of the third LFNST/NSPT kernel.

As already mentioned above, if all transform of a LFNST/NSPT set are selectable, “2” bits are required to encoded the “4” possible choices.

In case that the number of kernels is reduced to “1”, a single bit can be used. Otherwise, truncated unary code can be used for “2” kernels as shown in table TAB1:

In a variant of the fourth embodiment, the number of LFNST/NSPT kernels are reduced to “1” or “2” for non-I slices.

In another variant of the fourth embodiment, the number of LFNST/NSPT kernels are reduced to “1” for B slices and to “2” for P slices.

In a variant of the fourth embodiment, a high-level syntax element is signaled (typically a SPS level flag) to indicate if the number of LFNST/NSPT kernels is modified according to the slice type.

In another variant of the fourth embodiment, the number of kernels used for LFNST/NSPT is reduced to “1” or “2” based the temporal depth of the picture or slice comprising the current block as described in relation to FIG. 8.

In this variant, some picture header and/or slice header level syntax elements are introduced so as to indicate the LFNST/NSPT kernels allowed in the picture or slice.

These picture header and/or slice header level syntax elements can override SPS level LFNST/NSPT syntax elements to configure the LFNST/NSPT complexity level to a lower level than what is configured at SPS level. This high-level controlling feature allows tuning the LFNST/NSPT usage, typically as a function of the temporal depth of a picture/slice.

In another variant of the fourth embodiment, the number of kernels used for LFNST/NSPT is reduced based on characteristics of blocks in a causal neighborhood of the current block.

For example, in the third embodiment, the number of LFNST and NSPT kernels are reduced to “2” or “1” for a current block if most of the block in a causal neighborhood of the current block are coded in intra, thus limiting the LFNST/NSTP complexity where intra is used excessively. For example, the number of LFNST and NSPT kernels are reduced to “2” or “1” for a current block if more than the half of the block in a causal neighborhood of the current block are coded in intra.

In another example, the number of LFNST and NSPT kernels are reduced to “2” or “1” if most of the blocks in a causal neighborhood of the current block are coded in inter, thus limiting the LFNST/NSTP complexity where the current block is difficult to encode and LFNST is expected to provide significant coding gain.

In this variant of the fourth embodiment, a high-level syntax (for instance in SPS) element indicates that the number of LFNST and NSPT kernels are reduced to “2” or “1” based on a characteristic of at least one block in a causal neighborhood of the current block.

As can be seen, in the fourth embodiment, the number of selectable non-separable transforms depends on the slice type of the slice comprising the current block, the temporal depth of the picture or the slice comprising the current block or on characteristics of blocks in a causal neighborhood of the current block.

Another solution to reduce the complexity of non-separable transforms is by reducing the dimension of the LFNST and NSPT kernels. The basic idea here is to use smaller dimensions of kernels (by zeroing out last N basis vectors of kernels) on slices that are better predicted (e.g., typically B-slices) than others (e.g., I-slices).

In a fifth embodiment the dimension of LFNST and NSPT kernels selectable for a current block are reduced for P-slices and B-slices.

In a variant of the fifth embodiment, the dimension of the LFNST and NSPT kernels selectable for a current block is reduced only for B-slices.

In a variant of the fifth embodiment, the dimensions of LFNST and NSPT kernels selectable for a current block is reduced, but according to the temporal depth of the picture or slice comprising the current block. Table TAB2 below provides an example on how the dimension of kernels is reduced at different temporal depths.

TABLE TAB2

| Temporal depth | Kernel dimensions |
|---|---|
| I₀ | (LFSNT4, LFNST8, LFNST16) = |
| | (16 × 16, 32 × 64, 32 × 96) |
| B₁ | (LFSNT4, LFNST8, LFNST16) = |
| | (12 × 16, 24 × 64, 24 × 96) |
| B₂, B₃, . . . | (LFSNT4, LFNST8, LFNST16) = |
| | (8 × 16, 16 × 64, 16 × 96) |

In this variant of the fifth embodiment, some picture header (respectively slice header) level syntax elements are introduced so as to indicate the use of LFNST/NSPT kernels with reduced dimensions in the current picture (respectively slice).

Thus, these syntax elements override SPS level syntax elements defining LFNST/NSPT kernel dimensions. This overriding allows controlling at the picture/slice header level the LFNST/NSPT kernel dimensions and therefore the complexity of LFNST/NSPT.

In another variant of the fifth embodiment, the dimension of the LFNST and NSPT kernels selectable for a current block is reduced only for slices with the temporal depth value of “2” or more as depicted in FIG. 8.

As can be seen, in the fifth embodiment, the selectable non-separable transforms depend on the slice type of the slice comprising the current block, the temporal depth of the picture or the slice comprising the current block.

Reducing the LFNST/NSPT complexity while maintaining good performance compared to a full search on the LFNST/NSPT kernels can be achieved by an implicit obtaining of the LFNST/NSPT characteristics. This approach called implicit LFNST/NSPT in the following consists in inferring the best LFNST/NSPT kernel for a current block via information known on the decoder side. Thus, the encoder can benefit from all LFNST/NSPT options while limiting the number of options considered in the rate distortion optimization.

In a sixth embodiment, the LFNST/NSPT kernel is determined as a modulo of the intra prediction mode of a current block. For instance, The LFNST (respectively NSPT) kernel represented by an index Ifnst_idx (respectively nspt_idx) is determied as the intra prediction mode of the current block intramode modulo a total number of LFNST (respectively NSPT) kernels num_kernel:

$$lfnst\_idx = intramode \% num\_kernel + 1$$

$$nspt\_idx = intramode \% num\_kernel + 1$$

where “%” represents the modulo operation. The number of LFNST/NSPT kernels num_kernel is equal to “3” in last versions of LFNST/NSPT, +1 is added because “0” means LFNST/NSPT is not used, and “1” to num_kernel are the index of first to last LFNST/NSPT kernels.

The index Ifnst_idx (resp. nspt_idx) is coded using a single bit to signal if LFNST (resp. NSPT) is enabled or not for the current block. On the decoder side, the LFNST (resp. NSPT) kernel index is recovered using the intra prediction mode as in the encoder.

In a variant of the sixth embodiment, the number of LFNST/NSPT kernels num_kernel is reduced from “3” to “2” or “1”. The main benefit of this variant is that the encoder checks one or two kernels for each intra mode, instead of all kernels. This reduces the encoder complexity while keeping the performance high as all kernels are tested for different intra mode.

In a variant of the sixth embodiment, a high-level syntax element is signaled (typically as a SPS flag in a SPS) to indicate if implicit LFNST/NSPT is enabled for blocks referring to this SPS.

In a variant of the sixth embodiment, all LFNST/NSPT options (including no LFNST/NSPT) are distributed across consecutive intra modes. In this case, Ifnst_idx (resp. nspt_idx) is determined as the intra prediction mode intramode modulo the total number of LFNST kernels num_kernel+1.

In a variant of the sixth embodiment, implicit LFNST is only enabled for non-I slices.

In a variant of the sixth embodiment, implicit LFNST is only enabled for P-slices and disabled for B-slices.

In a variant of the sixth embodiment, implicit LFNST is enabled based on the picture or slice temporal depth.

In a variant of the sixth embodiment, a high-level syntax element is signaled (typically SPS flag in a SPS) to indicate the use of implicit LFNST for certain picture or slice types. The use of implicit LFNST can then be inferred at the picture level based on the picture temporal depth or at the slice level based on the slice type or on the slice temporal depth. No additional signaling is therefore required at picture or slice level.

As can be seen, in the sixth embodiment, the selectable non-separable transform depends on the intra prediction mode of the current block.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1-18. (canceled)

19. A device for video decoding, comprising:
a processor configured to:
receive a sequence parameter indication that indicates whether a first transform type is activated for a first slice type;
determine that a slice is of the first slice type;
determine, based on the sequence parameter indication, that the first transform type is not to be applied to the slice; and
decode the slice based on the determination that the first transform type is not be to applied to the slice.

20. The device of claim 19, wherein the slice is decoded based on a second transform type, wherein the first and second transform types are different.

21. The device of claim 19, wherein the sequence parameter indication is a first sequence parameter indication, the slice is a first slice, and wherein the processor is further configured to:
receive a second sequence parameter indication that indicates an activation of the first transform type for a second slice type; and
based on the second sequence parameter indication, decode a second slice of the second slice type using the first transform type.

22. The device of claim 19, wherein the processor is further configured to:
obtain a picture header associated with a picture;
determine, based on the picture header, that the sequence parameter indication is overridden;
based on determining that the sequence parameter indication is overridden, determine, using picture-level information, whether the first transform type is activated for the picture; and
decode the picture according to the picture-level information.

23. The device of claim 22, wherein the processor is further configured to:
determine a temporal depth associated with the picture in a hierarchical structure, wherein the picture-level information indicates the temporal depth associated with the picture, wherein the picture is decoded based on determining whether the first transform type is activated for the picture.

24. The device of claim 19, wherein the sequence parameter indication indicates the first transform type applicable to a sequence of pictures, and wherein the processor is further configured to:
determine, for a first picture of the sequence of pictures, that the first transform type is to be applied;
determine, for a second picture of the sequence of pictures, that a second transform type is to be applied based on a picture header associated with the second picture; and
decode the second picture based on an inverse transform of the second transform type.

25. The device of claim 19, wherein the processor is further configured to:
identify a plurality of neighboring blocks of a block;
determine a prediction type of a respective neighboring block of the plurality of neighboring blocks, wherein the prediction type indicates an intra-prediction type or an inter-prediction type; and
determine that the first transform type is to be applied based on a condition that the prediction type is a dominant prediction type among the plurality of neighboring blocks.

26. The device of claim 19, wherein the sequence parameter indication indicates that low-frequency non separable transforms (LFNST) and non-separable secondary transform (NSPT) are deactivated for non-intra slices, wherein the first slice type is a non-intra slice type, and the first transform type is LFNST or NSPT.

27. A device for video encoding, comprising:
a processor configured to:
determine that a slice is of a first slice type;
determine, based on the first slice type, that a first transform type is not to be applied to the slice;
encode the slice based on the determination that the first transform type is not be to applied to the slice; and
send a sequence parameter indication indicating that the first transform type is deactivated for the first slice type.

28. The device of claim 27, wherein the processor is further configured to:
identify a plurality of neighboring blocks of a block;
determine a prediction type of a respective neighboring block of the plurality of neighboring blocks, wherein the prediction type indicates an intra-prediction type or an inter-prediction type; and
determine that the first transform type is to be applied based on a condition that the prediction type is a dominant prediction type among the plurality of neighboring blocks.

29. The device of claim 27, wherein the sequence parameter indication indicates that low-frequency non separable transforms (LFNST) and non-separable secondary transform (NSPT) are deactivated for non-intra slices, wherein the first slice type is a non-intra slice type, and the first transform type is LFNST or NSPT.

30. A method for video decoding, comprising:
receiving a sequence parameter indication that indicates whether a first transform type is activated for a first slice type;
determining that a slice is of the first slice type;
determining, based on the sequence parameter indication, that the first transform type is not to be applied to the slice; and
decoding the slice based on the determination that the first transform type is not be to applied to the slice.

31. The method of claim 30, wherein the slice is decoded based on a second transform type, wherein the first and second transform types are different.

32. The method of claim 30, wherein the sequence parameter indication is a first sequence parameter indication, the slice is a first slice, and wherein the method further comprises:
receiving a second sequence parameter indication that indicates an activation of the first transform type for a second slice type; and
based on the second sequence parameter indication, decoding a second slice of the second slice type using the first transform type.

33. The method of claim 30, further comprising:
obtaining a picture header associated with a picture;
determining, based on the picture header, that the sequence parameter indication is overridden;
based on determining that the sequence parameter indication is overridden, determining, using picture-level information, whether the first transform type is activated for the picture; and
decoding the picture according to the picture-level information.

34. The method of claim 33, further comprising:
determining a temporal depth associated with the picture in a hierarchical structure, wherein the picture-level information indicates the temporal depth associated with the picture, wherein the picture is decoded based on determining whether the first transform type is activated for the picture.

35. The method of claim 30, wherein the sequence parameter indication indicates the first transform type applicable to a sequence of pictures, and wherein the method further comprises:
determining, for a first picture of the sequence of pictures, that the first transform type is to be applied;
determining, for a second picture of the sequence of pictures, that a second transform type is to be applied based on a picture header associated with the second picture; and
decoding the second picture based on an inverse transform of the second transform type.

36. A method for video encoding, comprising:
determining that a slice is of a first slice type;
determining, based on the first slice type, that a first transform type is not to be applied to the slice;
encoding the slice based on the determination that the first transform type is not be to applied to the slice; and
sending a sequence parameter indication indicating that the first transform type is deactivated for the first slice type.

37. The method of claim 36, further comprising:
identifying a plurality of neighboring blocks of a block;
determining a prediction type of a respective neighboring block of the plurality of neighboring blocks, wherein the prediction type indicates an intra-prediction type or an inter-prediction type; and
determining that the first transform type is to be applied based on a condition that the prediction type is a dominant prediction type among the plurality of neighboring blocks.

38. The method of claim 36, wherein the sequence parameter indication indicates that low-frequency non separable transforms (LFNST) and non-separable secondary transform (NSPT) are deactivated for non-intra slices, wherein the first slice type is a non-intra slice type, and the first transform type is LFNST or NSPT.
